(19) United States
(12) Patent Application Publication
(10) Pub. No.: US 2016/0111875 A1
(43) Pub. Date: Apr. 21, 2016

(54) ADAPTIVE ALL-IN-ONE DEVICE AND METHOD OF SUPPLYING POWER THERETO

(71) Applicants: HONG FU JIN PRECISION INDUSTRY (WUHAN) CO., LTD., Wuhan (CN); HON HAI PRECISION INDUSTRY CO., LTD., New Taipei (TW)

(72) Inventor: HUNG-CHI HUANG, New Taipei (TW)

(21) Appl. No.: 14/517,499

(22) Filed: Oct. 17, 2014

(51) Int. Cl. H02J 3/00; H02J 7/00

(52) U.S. Cl. CPC H02J 3/005; H02J 7/0068

(57) ABSTRACT

An adaptive all-in-one device includes a power switch module, a power module, a connection port switch module, and at least one connection port. The power switch module is configured to determine a power state of the device and transmit power to electronic components of the device. The power module is configured to receive power from either a main power source or at least one peripheral power source, and transmit the power to the power switch module. The connection port switch module is configured to transmit power from the power switch module to the at least one peripheral power source, and transmit power from the at least one peripheral power source to the power module. The at least one connection port is configured to electrically couple the connection port switch module of the device to the at least one peripheral power source.

### FIELD

The present disclosure relates to adaptive all-in-one devices, and particularly to an adaptive all-in-one device not requiring an internal power supply.

### BACKGROUND

Generally, adaptive all-in-one (aAIO) devices have display sizes greater than 21 inches in length. An aAIO device may have an internal battery that can be charged by a wall power source. After the internal battery is charged, the aAIO device can operate without being connected to the wall power source.

### BRIEF DESCRIPTION OF THE DRAWINGS

Implementations of the present technology will now be described, by way of example only, with reference to the attached figures.

FIG. 1 is a diagrammatic view of an exemplary embodiment of an adaptive all-in-one (aAIO) device.

FIG. 2 is similar to FIG. 1, but showing the aAIO device coupled to a main power source.

FIG. 3 is similar to FIG. 2, but showing the aAIO device coupled to the main power source and a peripheral power source.

FIG. 4 is similar to FIG. 3, but showing the aAIO device not coupled to the main power source.

FIG. 5 is a flowchart of an exemplary embodiment of a method for supplying power to the aAIO device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “comprising,” when utilized, means “including, but not necessarily limited to”; it specifically indicates open-ended inclusion or membership in the so-described combination, group, series, and the like.

The term “coupled” is defined as connected, whether directly or indirectly through intervening components, and is not necessarily limited to physical connections. The connection can be such that the objects are permanently connected or releasably connected.

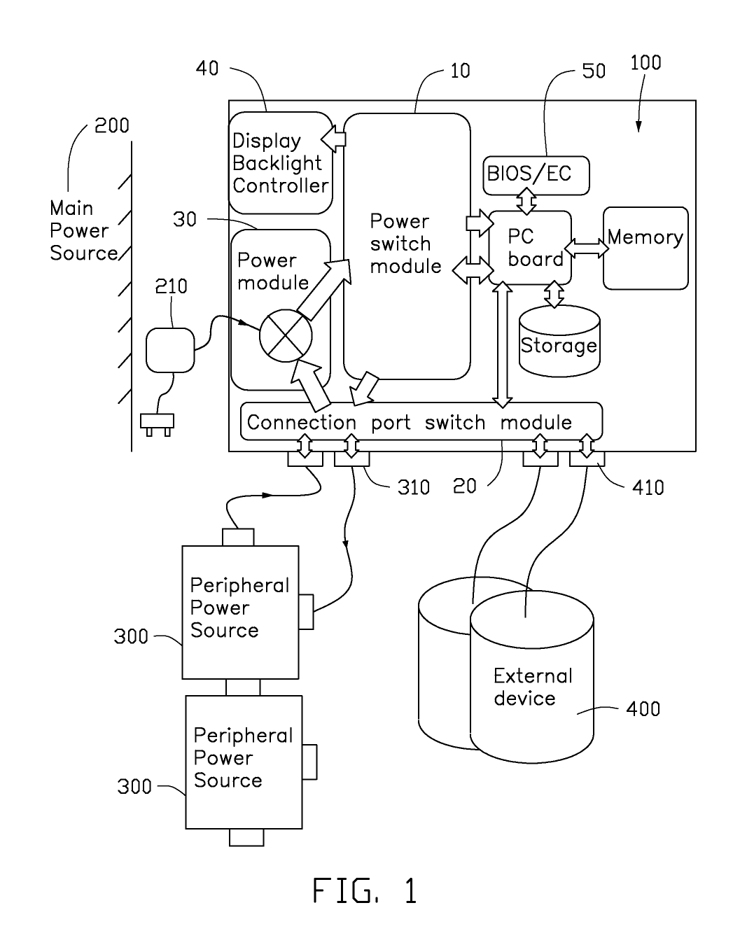

FIG. 1 illustrates an exemplary embodiment of an adaptive all-in-one (aAIO) device 100. The aAIO device 100 can receive power from a main power source 200 or at least one peripheral power source 300. The main power source 200 can be an alternating current (AC) power source, and the peripheral power source 300 can be a battery bank. The main power source 200 can be coupled to the aAIO device 100 through a direct current (DC) adaptor 210. The peripheral power source 300 can be coupled to the aAIO device 100 through at least one first connection port 310 of the aAIO device 100. In at least one embodiment, a plurality of peripheral power sources 300 can be linked together. In another embodiment, each of the plurality of peripheral power sources 300 can transmit power to the aAIO device 100 through corresponding first connection ports 310. The aAIO device 100 can also be connected to at least one external device 400 through at least one second connection port 410. In at least one embodiment, the first connection port 310 and the second connection port 410 can be universal serial bus (USB) ports. The aAIO device 100 can receive power from the main power source 200 or the peripheral power source 300. Thus, the aAIO device 100 does not require an internal battery, and a weight of the aAIO device 100 is effectively reduced.

The aAIO device 100 can include a power switch module 10, a connection port switch module 20, a power module 30, a display backlight controller 40, and a basic input output system/embedded chip (BIOS/EC) 50. The peripheral power source 300 can be connected to the connection port switch module 20 through the first connection port 310. When the aAIO device 100 receives power from the main power source 200, power from the main power source 200 can be transmitted to the power switch module 10 through the power module 30. When the aAIO device 100 receives power from the peripheral power source 300, power from the peripheral power source 300 can be transmitted to the power switch module 10 through the at least one first connection port 310, the connection port switch module 20, and the power module 30 in that order. The power switch module 10 can determine whether the aAIO device 100 is coupled to the main power source 200, the peripheral power source 300, both the main power source 200 and the peripheral power source 300, or neither the main power source 200 or the peripheral power source 300.

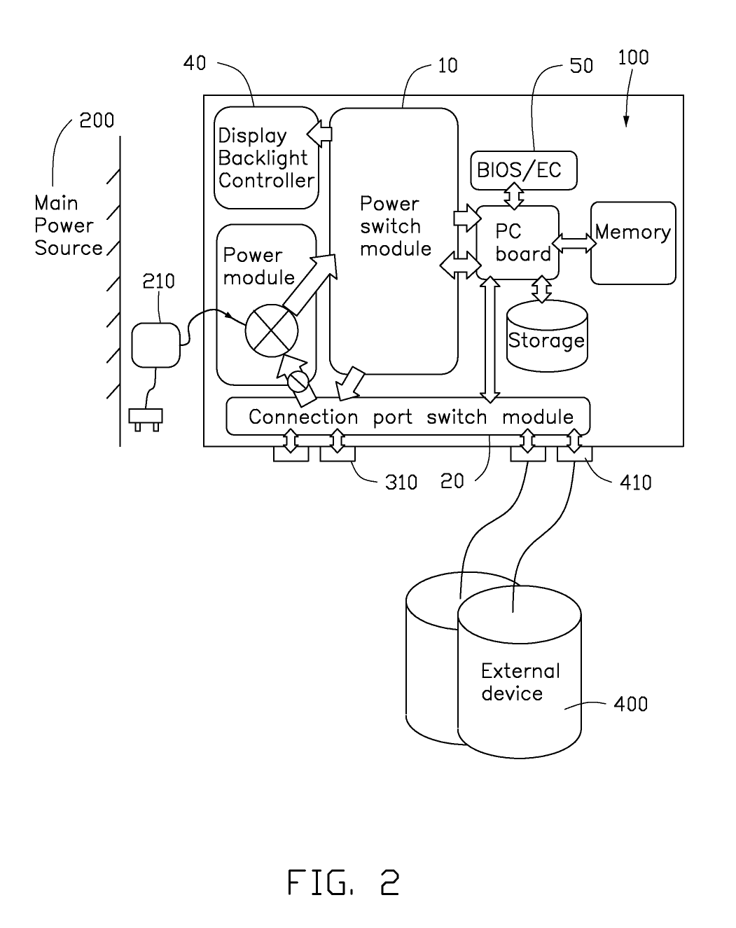

Referring to FIG. 2, when the aAIO device 100 is coupled to the main power source 200 and not the peripheral power source 300, power can be transferred to the power module 30 of the aAIO device 100 from the main power source 200, and the aAIO device 100 can be operated normally.

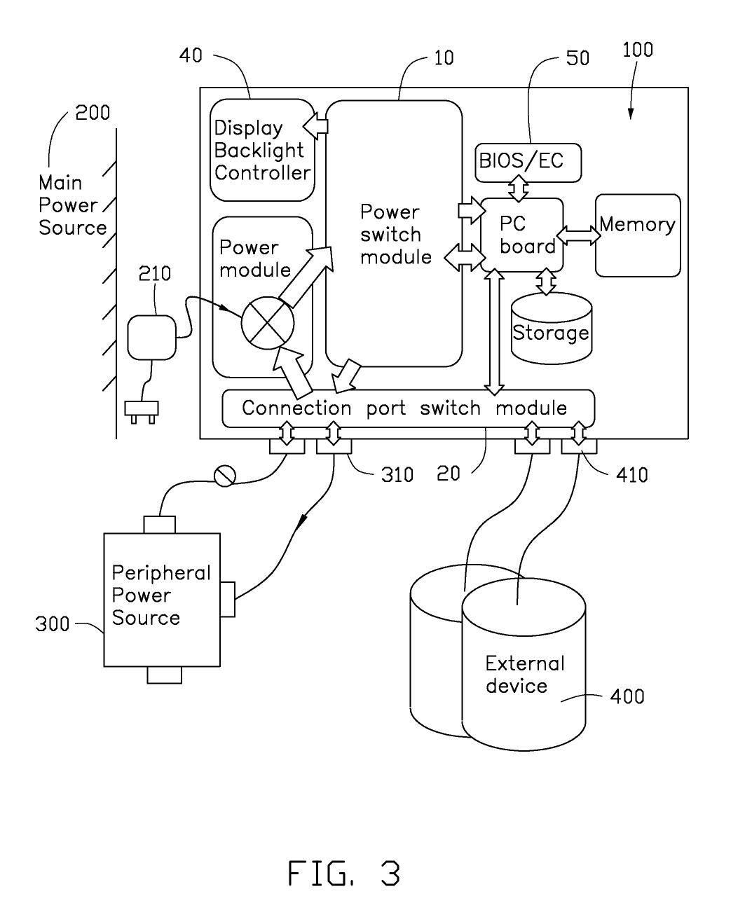

Referring to FIG. 3, when the aAIO device 100 is coupled to both the main power source 200 and the peripheral power source 300, power is transmitted to the aAIO device 100 from the main power source 200, and power from the main power source 200 is also transmitted to the peripheral power source 300 to charge the peripheral power source 300. In detail, power from the main power source 200 is transmitted to the power module 30, and then the power module 30 transmits the power to the power switch module 10. The power switch module 10 transmits the power to the display backlight controller 40 and other electronic components of the aAIO device 100, and further transmits the power to the connection port switch module 20. The connection port switch module 20 transmits the power through the first connection port 310 to the peripheral device 300 to charge the peripheral device 300.

When the aAIO device 100 is in the S4 or S5 power state while being coupled to both the main power source 200 and the peripheral power source 300, power is not transmitted from the power switch module 10 to the connection port switch module 20. Instead, if the aAIO device 100 is coupled to the external device 400 through the second connection port 410, power from the external device 400 can be transmitted to the connection port switch module 20 through the second connection port 410, and then transmitted to the peripheral power source 300 through the first connection port 310.

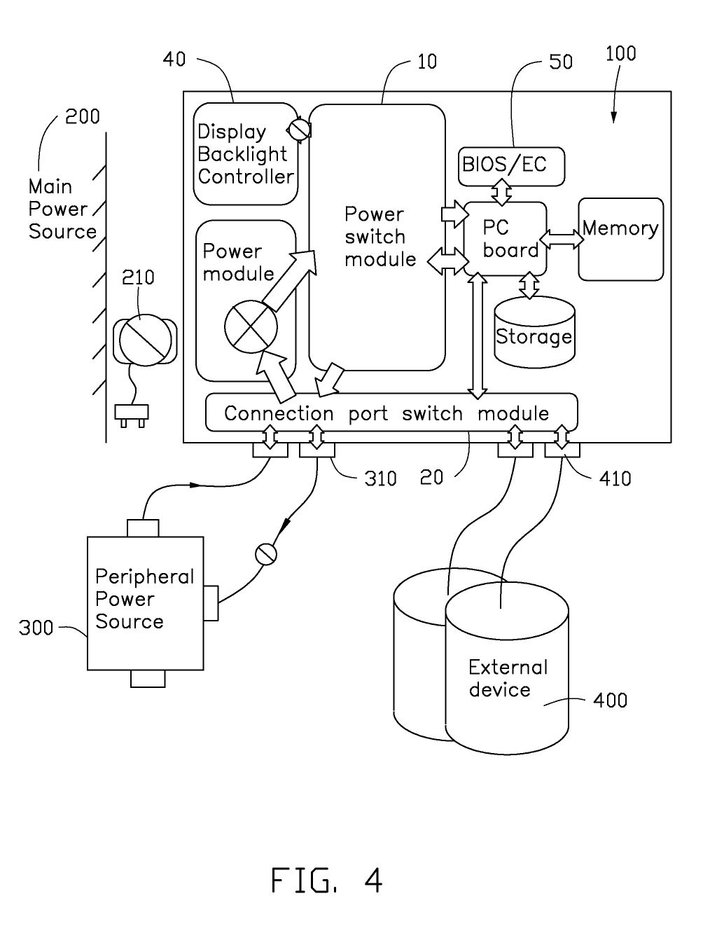

Referring to FIG. 4, when the aAIO device 100 is coupled to the peripheral power source 300 and not the main power source 200, power from the peripheral power source 300 is transmitted to the aAIO 100. In at least one embodiment, when the aAIO device 100 receives power from the peripheral power source 300, the power switch module 10 turns off the display backlight controller 40, and the BIOS/EC 50 controls the aAIO device 100 to operate in the S4 power state. In detail, when the aAIO device 100 operates in the S0 power state when coupled to the peripheral power source 300 and not the main power source 200, the BIOS/EC 50 controls the aAIO device 100 to switch directly to the S4 power state. When the aAIO device 100 operates in the S3 power state when coupled to the peripheral power source 300 and not the main power source 200, the BIOS/EC 50 first controls the aAIO device 100 to switch to the S0 power state, and then switch to the S4 power state. When the aAIO device 100 is in the S4 power state, the power switch module 10 stops outputting power to the connection port switch module 20.

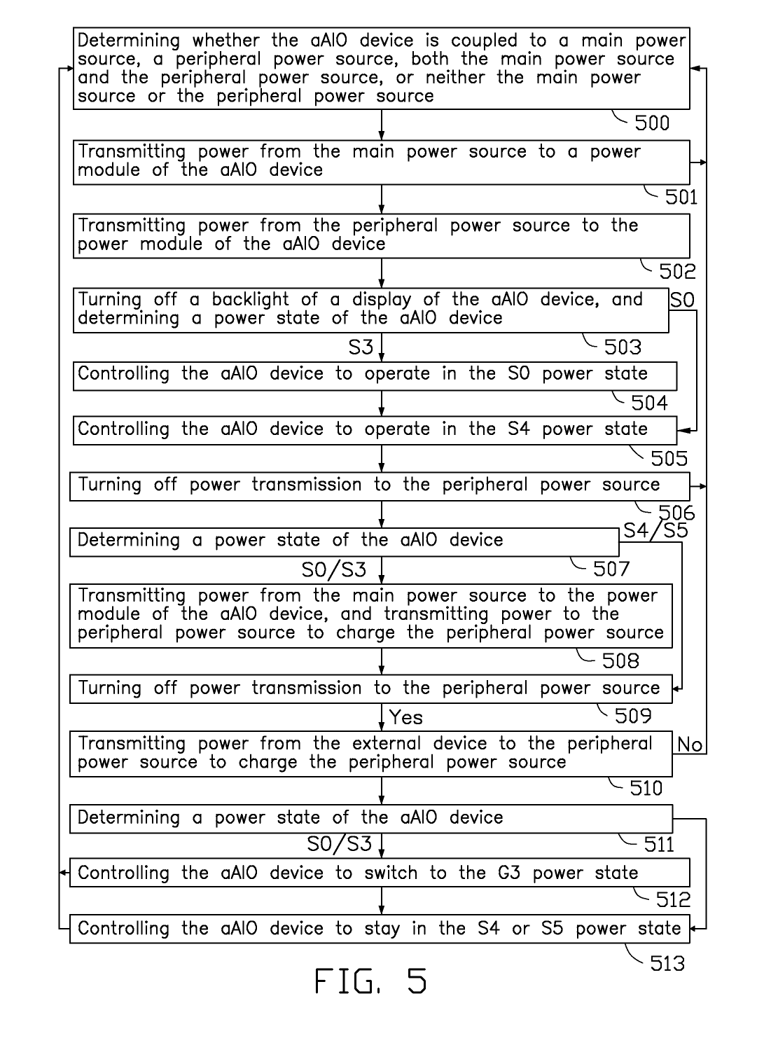

FIG. 5 illustrates a flowchart of a method for supplying power to an adaptive all-in-one device in accordance with an example embodiment. The method is provided by way of example, as there are a variety of ways to carry out the method. The method described below can be carried out using the configurations illustrated in FIGS. 1-4, for example, and various elements of these figures are referenced in explaining the example method. Each block shown in FIG. 5 represents one or more processes, methods, or subroutines carried out in the example method. Additionally, the illustrated order of blocks is by example only, and the order of the blocks can be changed. The example method can begin at block 501.

At block 500, the aAIO device determines whether it is coupled to a main power source, a peripheral power source, both the main power source and the peripheral power source, or neither the main power source or the peripheral power source. When the aAIO device is coupled to the main power source and not the peripheral power source, block 401 is implemented. When the aAIO device is coupled to the peripheral power source and not the main power source, block 402 is implemented. When the aAIO device is coupled to both the main power source and the peripheral power source, block 407 is implemented. When the aAIO device is coupled to neither the main power source or the peripheral power source, block 411 is implemented.

At block 501, power from the main power source is transmitted to a power module of the aAIO device, and the aAIO device can operate normally.

At block 502, power from the peripheral power source is transmitted to the power module of the aAIO device.

At block 503, a backlight of a display of the aAIO device is turned off, and a power state of the aAIO device is determined. When the aAIO device is in the S3 power state, block 404 is implemented. When the aAIO device is in the S0 power state, block 405 is implemented

At block 504, the aAIO device is controlled to operate in the S0 power state.

At block 505, the aAIO device is controlled to operate in the S4 power state.

At block 506, power transmission to the peripheral power source is turned off.

At block 507, a power state of the aAIO device is determined. When the aAIO device operates in the S0 or S3 power state, block 408 is implemented. Otherwise, when the aAIO device operates in the S4 or S5 power state, block 409 is implemented.

At block 508, power from the main power source is transmitted to the power module of the aAIO device, and to the peripheral power source to charge the peripheral power source.

At block 509, power transmission to the peripheral power source is turned off. When there is an external device coupled to the aAIO device, block 410 is implemented. Otherwise, when there is no external device coupled to the aAIO device, block 400 is implemented.

At block 510, power from the external device is transmitted to the peripheral power source to charge the peripheral power source.

At block 511, a power state of the aAIO device is determined. When the aAIO device is in the S0 or S3 power state, block 412 is implemented. When the aAIO device is in the S4 or S5 power state, block 413 is implemented.

At block 512, the aAIO device is controlled to switch to the G3 power state.

At block 513, the aAIO device is controlled to stay in the S4 or S5 power state.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An adaptive all-in-one device comprising:
a power switch module configured to determine a power state of the adaptive all-in-one device and transmit power to electronic components of the adaptive all-in-one device;
a power module configured to receive power from either a main power source or at least one peripheral power source, and transmit the power to the power switch module;
a connection port switch module configured to transmit power from the power switch module to the at least one peripheral power source, and transmit power from the at least one peripheral power source to the power module; and
at least one first connection port configured to electrically couple the connection port switch module of the adaptive all-in-one device to the at least one peripheral power source.

2. The device as in claim 1, wherein the device further comprises:
a display backlight controller electrically coupled to the power switch module and configured to provide a backlight of a display of the device; and
a basic input output system/embedded controller (BIOS/EC) configured to control the device to operate in different power states.

3. The device as in claim 2, wherein the first power source is an alternating current (AC) power source, and the second power source is a battery bank; and the device is coupled to the AC power source through a direct current (DC) adaptor.

4. The device as in claim 3, wherein the AC power source provides power for the device when the device is coupled to the AC power source and not coupled to the battery bank; the power bank provides power for the device when the device is coupled to the battery bank and not coupled to the AC power source; the AC power source provides power for the device when the power module is coupled to both the AC power source and the battery bank; and power from the AC power source charges the battery bank when the power module is coupled to both the AC power source and the battery bank.

5. The device as in claim 4, wherein the battery bank receives power from the AC power source by the power from the AC power source transmitting through the power module, the power switch module, the connection port switch module, and the at least one first connection port in that order.

6. The device as in claim 5, wherein the device receives power from the battery bank by the power from the battery bank transmitting through the at least one first connection port, the connection port switch module, and the power module in that order.

7. The device as in claim 6, wherein when the battery bank is fully charged, the connection port switch module stops transmitting power to the battery bank through the at least one first connection port.

8. The device as in claim 7, wherein the connection port switch module transmits power from the power switch module to the battery bank to charge the battery bank when the device operates in the S0 or S3 power state; and the power switch module stops transmitting power to the connection port switch module when the device operates in the S4 or S5 power state.

9. The device as in claim 8, wherein when the power module receives power from the battery bank and not from the AC power source, the power switch module turns off the display backlight controller, the BIOS/EC controls the device to operate in the S4 power state, and the power switch module stops transmitting power to the connection port switch module.

10. The device as in claim 9, wherein when the device is coupled to the AC power source, the device is able to operate in the S0, S3, S4, and S5 power states; when the device is not coupled to the AC power source or the battery bank, the device is able to operate in the S4 and S5 power states.

11. The device as in claim 3, wherein a plurality of battery banks can be coupled together, and a plurality of battery banks can be coupled to the device through corresponding first connection ports.

12. The device as in claim 8, wherein the device further comprises at least one second connection port coupled to the connection port switch module and configured to couple an external component to the device; when the power switch module stops transmitting power to the connection port switch module, power from the external component is transmitted to the battery bank through the at least one second connection port, the connection port switch module, and the at least one first connection port in that order to charge the battery bank.

13. A method for supplying power to an adaptive all-in-one device comprising:
determining whether the device is coupled to a main power source, a peripheral power source, both the main power source and the peripheral power source, or neither the main power source or the peripheral power source;
transmitting power to the device from the main power source when the device is coupled to the main power source and not the peripheral power source;
transmitting power to the device from the peripheral power source when the device is coupled to the peripheral power source and not the main power source;
transmitting power to the device and the peripheral power source when the device is coupled to both the main power source and the peripheral power source;
limiting the device to operate in certain power states when the device is not coupled to either the main power source or the peripheral power source; and
limiting the device to operate in certain power states when the device is coupled to the peripheral power source and not the main power source.

14. The method as in claim 13, wherein when the device is coupled to both the main power source and the peripheral power source, power is transmitted to the peripheral power source when the device is in the S0 or S3 power state, and not transmitted to the peripheral power source when the device is in the S4 or S5 power state.

15. The method as in claim 13, wherein when the device is coupled to the peripheral power source and not the main power source, a backlight of a display of the device is turned off.

16. The method as in claim 13, wherein when the device is not coupled to either the main power source or the peripheral power source and operating in the S0 or S3 power state, the device is switched to the G3 power state.

17. The method as in claim 15, wherein when the device is coupled to the peripheral power source and not the main power source, the device is controlled to switch to the S4 power state.

18. The method as in claim 15, wherein when the device is in the S3 power state, the device is first switched to the S0 power state, and then switched to the S4 power state; and when the device is in the S0 power state, the device is switched directly to the S4 power state.

19. The method as in claim 18, wherein after the device is switched to the S4 power state, power is not supplied to the peripheral power source, but power is transmitted from the peripheral power source to the device.
